(19) United States
(12) Patent Application Publication
(10) Pub. No.: US 2005/0047378 A1
(43) Pub. Date: Mar. 3, 2005

(54) Method, device,and software programs for correlating data sets

(76) Inventors: Martin Wuschke, Meine (DE); Boris Dannehr, Isenbuttel (DE)

Correspondence Address: BELL, BOYD & LLOYD, LLC, P. O. BOX 1135, CHICAGO, IL, 60690-1135, US

(21) Appl. No.: 10/482,650

(22) PCT Filed: May 17, 2002
(86) PCT No.: PCT/DE02/01989

(30) Foreign Application Priority Data
Jun. 25, 2001 (DE) 10130539.7

(51) Int. Cl. G06F 17/60

(52) U.S. Cl. 370/338; 705/1; 370/401

(57) ABSTRACT

A method is provided for correlating various charge data sets (CDR), which are produced in various network nodes (SGSN; GGSN; MMS-Relay) using a packet switching MMS-service for GSM and/or UMTS. Charge identification data is transferred from a network node (GGSN) of the core network to a network node (MMS-Relay) of the MMS-service supporting external network (PDN) by an interface (Gi) in order to correlate the CDRs of the network nodes (SGSN; GGSN) of the core network and the network node (MMS_Relay) of the external network via the charge identification data. Also provided are a corresponding method which is carried out for the MMS-Relay and corresponding devices and software programs.

### BACKGROUND OF THE INVENTION

The present invention relates to methods for correlating various charge data records which are produced in various network nodes using a packet-switched MMS (MMS: Multimedia Messaging Service) for GPRS and UMTS.

The present invention further relates to corresponding devices and software programs.

There is provision in mobile radio technology for developing possibilities for making data available, and for transmitting such data, via what are termed MMS (MMS: Multimedia Messaging Services) services. Multimedia messaging service content comprises one or more elements such as text, voice, images and video. Detailed information about this can be found in the publications of 3GPP (3rd Generation Partnership Project) and ETSI (European Telecommunications Standards Institute), the contents of which (and also those of the other documents cited in the following) are hereby explicitly included in the disclosure. Reference is made to 3GPP TS 22.140 V4.0.1 and to 3GPP TS 23.140 V4.1.0, for instance, in connection with implementing MMS services.

Data is transmitted on either a circuit-switched or a packet-switched basis in the technology of the second mobile radio generation (GSM: Global System for Mobile communications) and of the third mobile radio generation (UMTS: Universal Mobile Telecommunication System). In the latter case, the data is transmitted in individual data packets via what is termed a packet data protocol (PDP); for example, IP.

For a definition of the type of PDP, see also GSM 03.60 or 3G TS 23.060; particularly, Chapter 9 and Annex A of 3G TS 23.060.

The present invention relates to the area of packet-oriented data transmission. Packet-switched services are logically implemented in the GSM and UMTS structure by interconnecting two types of network node—at least one serving GPRS support node (SGSN) and at least one gateway GPRS support node (GGSN)—which form a constituent part of what is termed the core network. The MMS relay and MMS server are network elements which are in the area of responsibility of an MMS service provider and which make the MMS functionality available to the various users. An overview of the logical architecture of what is termed the packet domain (PD), including a description, can be found in ETSI GSM 12.15 V6.2.0 and in ETSI TS 32015 V3.4.0, see, in particular, FIG. 1.

Gathering of the charging records containing information about the services used is provided according to the previously cited publications via what is termed the charging gateway functionality (CGF); see, in particular, FIG. 2 in the cited ETSI GSM 12.15 V6.2.0 and 3G TS 32015 V3.4.0. Charge information here is transmitted from the SGSNs and GGSNs (the “s” ending employed in abbreviations here and henceforth designates the plural) to the network operator's charging or invoicing system, referred to as the billing system (BS). This requires the provision of a logical interface between the CGF and BS. The CGF can be embodied as a central, separate network element or it can be localized in the SGSNs and GGSNs with distributed functionality.

Charge information in the GPRS network is preferably collected for each mobile station (MS) or, in generalized terms, for each item of user equipment (UE), by the SGSNs and GGSNs serving these MSs or UEs. For each MS or UE the SGSN collects charge information associated with use of the radio network such as the volume of transmitted data and the length of time the packet data protocol (PDP) services were used. For each MS or UE, the GGSN collects charge information associated with use of the external data network such as source and destination addresses and use of the PDP addresses. The external networks can be identified here via the respective access point name (APN) (for a definition, see also GSM 03.60 or 3G TS 23.060) serving as a reference for the respectively employed GGSN. Optionally, the APN also may identify a service requiring to be offered. The interface between the GPRS and external packet data network has the general designation Gi.

Both nodes, namely SGSN and GGSN, also collect subscriber-related charge information concerning use of the GPRS network resources. The charge data records (CDRs) produced by the SGSN and GGSN are gathered by the CGF and transported to the charging or invoicing system (billing system, BS).

The charge data records (CDRs) from nodes SGSN and GGSN are mutually correlated in the network operator's post-processing center with the aid of what is termed the charging ID. A definition and details of the motivation for the charging ID can be found in the GSM 12.15 specifications (section 5.4) for GSM-GPRS and the 3G TS 32.015 V3.4.0 specifications (section 5.4) for UMTS. It is particularly important here that the charging ID, which is produced in a GGSN, is also unique within other operators' mobile radio networks. The charging ID is produced for an activated PDP context by the GGSN and transmitted to the corresponding SGSN to permit the charge data records to be correlated during post-processing.

Provision also has been made for generating CDRs in the elements of the multimedia messaging service (MMS). The possibility of generating CDRs in an MMS relay is described in 3G TS 22.140 V4.0.1 (section 8) and in 3G TS 23.140 V4.1.0 (section 5.3).

To date, the mutual correlation of charge data records produced in the nodes involved in service provisioning has not been possible. The network operator consequently is unable to bill jointly for the transportation of data and for the value added of an MMS, or to register these at all. Nor is it possible to perform what is termed content charging in the SGSN and GGSN network nodes. In particular, it also has not been possible to provide transportation and content together free of charge. This function is desirable, for instance, to allow users to receive an MMS free of charge.

An object of the present invention is, therefore, to enable simple charge logging when MMS services are used within the domain of most recent mobile radio technologies.

### SUMMARY OF THE INVENTION

Accordingly, the present invention permits the CDRs produced in the network elements involved in provisioning of the MMS service to be mutually correlated. The charging ID already present in the GGSN is, for this purpose, preferably transmitted to the MMS relay node. It is then entered there in the CDRs of the MMS relay which are produced while the MMS service is being used.

A particular advantage of the present invention is that it enables the network operator to produce a joint invoice both for transporting the data (use of the CDRs from SGSN and GGSN) and for the content of the transported data (the content constitutes the actual value added of the MMS service). A further advantage is that different network operators are able to mutually correlate their CDRs from SGSN, GGSN, and MMS relay with the aid, in particular, of the charging ID. In an extreme case, up to three different network operators can be involved in providing an MMS service of this type. Owing to the correlation according to the present invention, it also is moreover possible to provide data transportation and content together free of charge.

Moreover, in the case of roaming, it is possible via the present invention for different network operators involved in providing the service to mutually correlate their CDRs.

In order to exchange the charge identification data, particularly, the charging ID, the possibility must be provided by the GGSN of retrieving this data over the Gi interface. For this purpose, use preferably is made in the network node GGSN of data or field entries which are specific to MMS applications and with the aid of which the MMS relay recognizes that it is able to retrieve this charge identification data and, in particular, the charging ID from the GGSN of the core network.

This possibility of retrieval can be indicated in an advantageous embodiment of the present invention via a new type of PDP designated “MMS”, for example, to signify that such type of PDP relates to the multimedia messaging service. When, via their mobile station, users activate a PDP context containing the type of PDP designated “MMS”, the SGSN sets up a connection (tunnel) to the GGSN for this PDP context. Furthermore, a connection is set up from the GGSN to an MMS relay. It is known in the SGSN and GGSN from the type of PDP designated “MMS” that one or more MMS messages are being exchanged via this PDP context. The type of PDP designated “MMS” is advantageously added to the type-of-PDP field already existing according to the prior art in the CDRs of SGSN and GGSN. It is furthermore known in the GGSN from the type of PDP designated “MMS” that the interface partner on the Gi interface is an MMS relay. The charging ID then may be made available in the GGSN in such a way that via messages to be suitably defined in the standards it can be retrieved from the GGSN via the MMS relay and entered in the CDR of the MMS relay.

According to this first embodiment of the present invention an additional type of PDP is accordingly introduced to take its place alongside the types of PDP already known. Being expediently implementable fairly simply and in a manner compatible with other systems through the addition of a further protocol, this new type of PDP is particularly advantageous for international roaming. An APN that is unmodified in terms of the prior art preferably is employed for this embodiment, an APN being familiar as the Gi interface's logical point identifying a GSGN. According to the present invention, the new type of PDP can be used extensively for characterizing the use of MMS services, which is to say not only in conjunction with the charging ID and CDRs.

In an alternative embodiment of the present invention use is made of a special APN. As is known, the APN field for entering an APN already exists in the CDRs of SGSN and GGSN. The respective APN is dependent on the network and/or provider and can be determined by, for instance, the mobile device, the HLR (Home Location Register, see, for instance, 3G TS 23.060) or HSS (Home Subscriber Server) or by the SGSN (see, for instance, 3G TS 23.060, Annex A.2). When a PDP context is activated for an MMS message via the user's mobile station, according to the second embodiment of the present invention the type of PDP is in contrast to the exemplary embodiment described previously of the conventional type, while the APN is specifically selected as a source of identifying an MMS service. Via the special APN a GGSN is selected via which a transparent IP connection is set up to a computer which is located in a packet-switched network and which supports the MMS service. An MMS message can be sent or requested by the user (MMS MO service: Multimedia Messaging Service Mobile Originated) via the connection which has been set up.

Here, the GGSN is aware that the special APN stands for an MMS message. An internal or external database containing the relevant information is expediently available to the GGSN for this purpose. If there is a requirement for the relationship between the special APN and the MMS message to be known to the SGSN as well, a suitable database also must be provided for the SGSN.

From the special APN it is also recognized in the GGSN that the interface parameter on the Gi interface is an MMS relay. Consequently, the GGSN can take measures permitting the charging ID for the activated PDP context to be transmitted to the MMS relay in response to the relay's request. This requires defining appropriate messages in the standards. The MMS relay then retrieves the charging ID from the GGSN and enters it in the CDR produced by the MMS relay. Examples of other data which can be contained in this CDR are the type of MMS, time stamp, and volume of the MMS message.

In the case of retrieval of the charging ID (whether according to the first or second embodiment of the present invention) the GGSN acts as a server and the MMS relay as a client.

Additional features and advantages of the present invention are described in, and will be apparent from, the following Detailed Description of the Invention and the figures.

### BRIEF DESCRIPTION OF THE FIGURES

FIG. 1 shows a network structure of packet-switched data services and the linking of an MMS relay which substantially corresponds to the prior art.

### DETAILED DESCRIPTION OF THE INVENTION

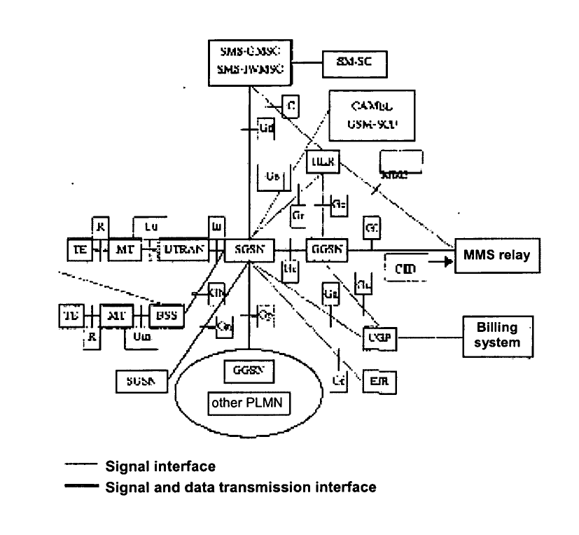

The network structure shown in FIG. 1 corresponds substantially to the packet domain logical architecture as is known, for example, from FIG. 2 of 3G TS 23.060. Only a section of this architecture is of significance for explaining the present invention; the above sources should be referred to for further details.

In a device designated as a mobile termination MT, a terminal device referred to as a mobile station (MS) or as an item of user equipment (UE) incorporates all the functions required for radio transmission and, furthermore, a subscriber interface which is located on the terminal TE (not shown) and via which the end-to end connections between applications are implemented. R refers to a reference point between a non-ISDN compatible TE and MT. The MT is connected via a reference point Uu to an access network for enabling access to the UMTS network. According to FIG. 1, the access network, also referred to as AND (Access Network Domain), can be implemented via either an UTRAN (UMTS Terrestrial Radio Access Network) or a GSM-BSS (Global System for Mobile Communication Base Station (sub)System). An MT can be connected to the core network domain via the UTRAN by what is termed an Iu interface or via the BSS through an interface Gb.

The core network domain is substantially implemented via two network nodes. This is, on the one hand, the SGSN (Serving GPRS Support Node) and, on the other hand, the GGSN (Gateway GPRS Support Node). The SGSN therefore can support GPRS both for GSM and for UMTS. The SGSN and GGSN are interconnected via an interface Gn. As indicated in the lower section of FIG. 1, the SGSN is able to communicate with other SGSNs or GGSNs in either its own network or in other networks (“other PLMN”).

The GGSN is able to connect via an interface Gi to a PDN (Public Data Network) of which only an MMS relay is shown which is connected via an interface to an MMS (Multimedia Messaging Service) server.

Charge data records (CDRs) are produced in the network nodes SGSN and GGSN and in the MMS relay to enable users to be invoiced for the services provided. A charging ID, abbreviated in FIG. 1 as CID, is additionally produced for this in the GGSN. According to the present invention, this charging ID is now also made available to the MMS relay via the Gi interface. The CDR of the MMS relay can be correlated in the charging or invoicing center (billing system) with the CDRs of the SGSN and GGSN with the aid of this charging ID. This can be implemented by way of, for example, the two embodiments described below.

In a first exemplary embodiment of the present invention users employ their mobile station (Mobile Station, MS or User Equipment, UE) to activate a PDP context with the type of PDP newly defined according to this exemplary embodiment having the exemplary designation “MMS” and having any “access point name” (APN), with the APN indicating the logical point of the Gi interface and being able to be used for selecting the GGSN. The flow of operations taking place when a PDP context is activated is presented in GSM 03.60 for GPRS-GSM and in 3G TS 23.060 for UMTS; see, in particular, Annex A.2. A connection is set up to the MMS relay via the GGSN because the user wants to send an MMS message (MMS M0 service).

The fact that it is an MMS message is recognized in the SGSN and GGSN from the new type of PDP designated “MMS”. This type of PDP is incorporated in the CDRs generated by SGSN and GGSN. The type-of-PDP field already exists in the CDRs of these nodes. It is only necessary to add the new type of PDP.

It is also recognized in the GGSN from the type of PDP designated “MMS” that the interface partner on the Gi interface is an MMS relay. As such, the GGSN can take measures permitting the charging ID for the activated PDP context to be transmitted to the MMS relay in response to the relay's request. This then requires defining appropriate messages in the standards.

The MMS relay then retrieves the charging ID from the GGSN and enters it in the CDR produced by the MMS relay. Examples of other data which can be contained in this CDR are the type of MMS, time stamp, and volume of the MMS message.

According to a second exemplary embodiment of the present invention, users also employ their mobile station to activate a PDP context, but in this case with a conventional type of PDP and a special APN, which is to say an APN specific to MMS. With the aid of the APN, a GGSN is selected via which a transparent IP connection is set up to a computer in a packet-switched network. The GGSN recognizes from the specific APN that such computer is an MMS relay. For this the GGSN must have, for example, a database which images an APN onto a node type (in this case, “MMS relay”). An MMS message can be sent by the user via the connection which has been set up (MMS M0 service).

The fact that it is an MMS message is recognized in the GGSN from the special or specific APN. Such APN is incorporated in the CDRs generated by SGSN and GGSN. The APN field already exists in the CDRs of these nodes. Unless it also has access to a database representing an association between APN and MMS service, the SGSN in this case will be unable to recognize that it is an MMS message.

It is also recognized in the GGSN from the special APN that the interface partner on the Gi interface is an MMS relay. The GGSN, consequently, can take measures permitting the charging ID for the activated PDP context to be transmitted to the MMS relay in response to the relay's request. This then requires defining appropriate messages in the standards.

The MMS relay then retrieves the charging ID from the GGSN and enters it in the CDR produced by the MMS relay. As in the first exemplary embodiment, examples of other data which can be contained in this CDR are the type of MMS, time stamp, and volume of the MMS message.

In contrast to the second exemplary embodiment, the first exemplary embodiment requires no additional databases in the SGSN or GGSN. Correlating of the CDRs for post-processing is enabled via the universally-known type of PDP with the exemplary designation “MMS” and through exchanging of the charging ID. The first exemplary embodiment additionally permits special handling of MMS messages in SGSN and GGSN (if such nodes are not situated in the user's home network) because in this case the network operators do not have to exchange all the special “MMS APNs” with each other. The first exemplary embodiment with the new type of PDP designated “MMS” thus advantageously supports the international roaming required in GSM and UMTS.

The present invention can, in particular, be used for implementing the respective procedural steps for network nodes or network elements of the type SGSN, GGSN, and MMS relay. Such implementation is carried out via suitable software programs which form a constituent part of the present invention and which can be appropriately loaded onto such devices and/or can run on these. The present invention also relates to mobile telecommunication devices, such as mobile telephones, which have their own processor or which are connected to a processor (such as that belonging to a connected laptop, a notebook, or an organizer, and the like), with the possibility of executing or initiating the procedural steps according to the present invention via this arrangement. Realization likewise is provided through the implementation of suitable software programs.

The present invention, in particular, includes mobile telecommunication devices with a processor (or which are connected to a processor) which is embodied such that the cited additional type of PDP (“MMS”) or as is also embodied an MMS specific APN can be co-activated when a PDP context is activated by a user. The additional type of PDP (“MMS”) in particular can be used for many kinds of signaling. For example, via this new type of PDP it can be recognized in the SGSN and/or GGSN that the subscriber has dialed an MMS service. According to the present invention, this information then can be used in these network nodes to initiate the MMS-related transmission of signals and/or data to or from other network elements.

Although the present invention has been described with reference to specific embodiments, those of skill in the art will recognize that changes may be made thereto without departing from the spirit and scope of the present invention as set forth in the hereafter appended claims.

1. Method for correlating various charge data records (CDRs) which are produced in various network nodes (SGSN, GGSN, MMS relay) using a packet-switched MMS (MMS: Multimedia Messaging Service) service for GMS and/or UMTS, with charge identification data being transmitted via an interface (Gi) from a network node (GGSN) in the core network to a network node (MMS relay) in an external network (PDN) supporting the MMS service in order to correlate the CDRs of the network nodes (SGSN; GGSN) in the core network and of the network node (MMS relay) in the external network by means of this charge identification data.

2. Method according to claim 1,
characterized in that
the charge identification data represents the charging ID produced by a network node (GGSN) in the core network.

3. Method according to one of the preceding claims,
characterized in that
data or field entries specific to MMS applications are employed in the core network's network node (GGSN) connected to the external network and serve to allow the network node (MMS relay) of the external network (PDN) to recognize that it is able to retrieve the charge identification data or charging ID from this network node (GGSN) of the core network.

4. Method according to claim 3,
characterized in that
an additional type of packet data protocol (PDP) (“MMS”) is employed when a user activates a PDP context with an MMS reference.

5. Method according to claim 4,
characterized in that
the additional type of PDP (“MMS”) is entered in the type-of-PDP field of the charge data record (CDR) of the core network's network node (GGSN) which is to be connected to the external network.

6. Method according to claim 4 or 5,
characterized in that
the additional type of PDP (“MMS”) is entered in the type-of-PDP field of the charge data record (CDR) of the core network's SGSN.

7. Method according to claim 3,
characterized in that
an access point name (APN) is employed which is specific to MMS applications and which is co-activated when a user activates a PDP context with an MMS reference.

8. Method according to claim 7,
characterized in that
the MMS-specific APN is entered in the APN field of the charge data record (CDR) of the core network's network node (GGSN) which is to be connected to the external network.

9. Method according to claim 7 or 8,
characterized in that
the MMS-specific APN is entered in the APN field of the charge data record (CDR) of the core network's SGSN.

10. Method for correlating various charge data records (CDRs) which are produced in various network nodes (SGSN, GGSN, MMS relay) using a packet-switched MMS (MMS: Multimedia Messaging Service) service for GMS and/or UMTS, with charge identification data present in a network node (GGSN) of the core network being retrieved via an interface (Gi) by a network node (MMS relay) of an external network (PDN) supporting the MMS service in order to correlate the CDRs of the network nodes (SGSN; GGSN) in the core network and of the network node (MMS relay) in the external network by means of this charge identification data.

11. Method according to claim 10,
characterized in that
the charge identification data or charging ID is entered in the charge data record (CDR) of the network node (MMS relay) of the external network (PDN).

12. Device with a processor which is set up such that it is able to implement the procedural steps on the part of the network nodes (SGSN; GGSN; MMS relay) of the core network or external network (PDN) according to one of the claims 1 to 11.

13. Device according to claim 12,
characterized in that
it is embodied as a GGSN, SGSN or MMS relay.

14. Mobile telecommunication device with a processor or which is connected to a processor by means of which an additional type of packet data protocol (PDP) (“MMS”) or an MMS-specific APN can be co-activated when a PDP context is activated by a user in order, in particular, to initiate the implementation of procedural steps according to one of the claims 1 to 11.

15. Software program capable of running on a device with a processor or which is connected to a processor, in particular a device according to one of the claims 12 to 14, such that the software program together with the device including the processor executes or initiates the procedural steps on the part of the network nodes (SGSN; GGSN; MMS relay) of the core network or external network (PDN) according to one of the claims 1 to 11.

16. Software program which can be loaded into a device with a processor or which is connected to a processor, in particular a device according to one of the claims 12 to 14, such that the thus programmed device including the processor is capable of or adapted for executing or initiating procedural steps on the part of the network nodes (SGSN; GGSN; MMS relay) of the core network or external network (PDN) according to one of the claims 1 to 11.

17. Software program product which comprises a processor-readable storage medium on which a program can be stored which, having been loaded, will enable a device, in particular a device according to one of the claims 12 to 14, to execute or initiate the procedural steps on the part of the network nodes (SGSN; GGSN; MMS relay) of the core network or external network (PDN) according to one of the claims 1 to 11.
